(19) United States
(12) Patent Application Publication
(10) Pub. No.: US 2007/0298167 A1
(43) Pub. Date: Dec. 27, 2007

(54) OZONE ABATEMENT IN A RE-CIRCULATING COOLING SYSTEM

(75) Inventors: DUSTIN W. HO, Fremont, CA (US); Juan Carlos Rocha-Alvarez, Sunnyvale, CA (US); Dale R. Du Bois, Los Gatos, CA (US); Scott A. Hendrickson, Brentwood, CA (US); Sanjeev Baluja, San Francisco, CA (US); Ndanka O. Mukuti, Santa Clara, CA (US)

Correspondence Address: TOWNSEND AND TOWNSEND AND CREW LLP / AMAT, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 11/556,787

(22) Filed: Nov. 6, 2006

Related U.S. Application Data
(60) Provisional application No. 60/816,800, filed on Jun. 26, 2006.

(51) Int. Cl. B05D 7/22

(52) U.S. Cl. 427/230

(57) ABSTRACT

A re-circulating cooling system can be used with a curing system in order to reduce the exhaust requirements for the system. Further, using a cooling fluid such as nitrogen reduces the production of ozone and the sealing requirements for the system. A simple heat exchanger can be used between return and supply reservoirs in order to remove heat added to the re-circulating fluid during circulation past the curing radiation source. The nitrogen can come from a nitrogen source, or from a membrane or other device operable to split feed gas into its molecular components to provide a source of gas rich in nitrogen. An ozone destruction unit can be used with such a cooling system to reduce the amount of ozone to acceptable levels, and to minimize consumption of the nitrogen. A catalyst can be used to deplete the ozone that does not get consumed during the reaction.

### CROSS-REFERENCE TO RELATED APPLICATIONS

This application claims priority to U.S. Provisional Application No. 60/816,800, entitled “Nitrogen Enriched Cooling Air Module for UV Curing System,” filed Jun. 26, 2006, which is hereby incorporated herein by reference. This application is also related to co-pending U.S. patent application Ser. No. ______, entitled “Nitrogen Enriched Cooling Air Module for UV Curing System,” filed concurrently with this application, Attorney Docket No. A 11181/T74610, which is hereby incorporated herein by reference.

### BACKGROUND OF THE INVENTION

Materials such as silicon oxide (SiOₓ), silicon carbide (SiC), and carbon doped silicon oxide (SiOCₓ) films find widespread use in the fabrication of semiconductor devices. One approach for forming such silicon-containing films on a semiconductor substrate is through the process of chemical vapor deposition (CVD) within a chamber. For example, a chemical reaction between a silicon supplying source and an oxygen supplying source may result in deposition of solid phase silicon oxide on top of a semiconductor substrate positioned within a CVD chamber. As another example, silicon carbide and carbon-doped silicon oxide films may be formed from a CVD reaction that includes an organosilane source including at least one Si—C bond.

Water is often a by-product of such a CVD reaction of oganosilicon compounds. As such, water can be physically absorbed into the films as moisture or incorporated into the deposited film as Si—OH chemical bond. Either of these forms of water incorporation is generally undesirable. Accordingly, undesirable chemical bonds and compounds such as water are preferably removed from a deposited carbon-containing film. Also, in some particular CVD processes, thermally unstable or labile organic fragments of sacrificial materials (resulting from porogens used during CVD to increase porosity) need to be removed.

One common method used to address such issues is a conventional thermal anneal. The energy from such an anneal replaces unstable, undesirable chemical bonds with more stable bonds characteristic of an ordered film thereby increasing the density of the film. Conventional thermal anneal steps are generally of relatively long duration (e.g., often between 30 min to 2 hrs.) and thus consume significant processing time and slow down the overall fabrication process.

Another technique to address these issues utilizes ultraviolet (UV) radiation to aid in the post treatment of CVD-produced films such as silicon oxide, silicon carbide, and carbon-doped silicon oxide films. For example, U.S. Pat. Nos. 6,566,278 and 6,614,181, both to Applied Materials, Inc. and incorporated by reference herein in their entirety, describe the use of UV light for post treatment of CVD carbon-doped silicon oxide films. The use of UV radiation for curing and densifying CVD films can reduce the overall thermal budget of an individual wafer and speed up the fabrication process. A number of various UV curing systems have been developed which can be used to effectively cure films deposited on substrates. One example of such is described in U.S. application Ser. No. 11/124,908, filed May 9, 2005, entitled “High Efficiency UV Curing System,” which is assigned to Applied Materials and incorporated herein by reference for all purposes.

Because the UV sources used for curing tend to build up heat over time that can negatively impact the devices being processed and shorten the life of the sources themselves, there is a need to cool these existing UV and other curing sources, as well as to cool the electronics and various other components. Typically, an open loop system is used, such as shown in the arrangement 100 of FIG. 1, wherein a blower 106 is used to direct ambient air into an end of a UV source, such as a UV lamp module 102 used to direct UV radiation into a processing (curing) chamber 104. An exhaust port 108 is positioned at the other end of the UV source so that the heated air is directed out of the lamp module, thereby removing heat from the module 102. There are various downsides to such an approach.

One downside is that the heated air must be exhausted outside the system, adding cost and complexity to the exhaust apparatus for the overall processing line. Another downside is that the use of ambient air leads to a substantial amount of oxygen leaking into the lamp module and/or curing chamber. The presence of oxygen limits the wavelength in the UV spectrum at which the system can operate, as lower wavelengths (e.g., below 200 nm) tend to be absorbed by the oxygen. This effect can be mitigated to some extent by increasing the seal requirements for the curing system, but this again increases the cost and complexity of the curing system.

Another problem is that exposure of any oxygen in the system to UV radiation generates trace amounts of ozone in the system. This ozone leads to consumption of the nitrogen in the system. Further, there are strict requirements on the amount of ozone that can be present in such a system, and the continual generation of ozone during processing can lead to unacceptable levels of ozone that must be detected and addressed before processing can continue.

For reasons including these and other deficiencies, and despite the development of various curing chambers and techniques, further improvements in this important technology area are continuously being sought.

### BRIEF SUMMARY OF THE INVENTION

Systems and methods in accordance with various embodiments of the present invention provide for the re-circulation of a fluid in a UV curing system or device, such as by utilizing a re-circulation cooling system or closed-loop cooling system (CLCS). Such re-circulation can reduce the exhaust and seal requirements for the curing system. The use of a re-circulating fluid such as nitrogen also can reduce the production of ozone in the system, and can allow for operation of the curing system at lower wavelengths. Such re-circulation also can provide for the reduction of ozone concentration in the re-circulating fluid.

In one embodiment, a system for providing cooling for a UV curing system including a UV lamp source and a curing chamber includes a supply reservoir operable to contain a volume of fluid. A flow generating device, such as a blower, can direct a flow of fluid from the supply reservoir past the UV lamp source, such that the flow of fluid can remove heat energy from the UV lamp source. Return piping connected to the curing chamber can receive the heated flow of fluid and direct the flow of heated fluid to a return reservoir. A heat exchanger positioned along a flow path between the return reservoir and the supply reservoir can remove the heat energy from the heated flow of fluid, whereby the flow of fluid can be directed back into the supply reservoir to be re-circulated as a cooling fluid. The fluid can be any appropriate liquid or gas, such as a nitrogen gas or nitrogen-enriched gas. A gas separation module can be used that receives a flow of feed air and separates out at least one component of the feed air to generate a source of the fluid for the supply reservoir. The gas separation module can include a gas separation membrane, for example, which can receive a flow of feed air and produce a flow of nitrogen.

In one embodiment, an air module is provided for generating a re-circulating flow of cooling fluid for a radiation-based curing device. The module contains a supply reservoir operable to receive and contain a volume of fluid. A flow generating device can direct a flow of fluid from the supply reservoir to the radiation-based curing device, the flow of fluid operable to remove heat energy from the curing device. A return reservoir can receive the heated flow of fluid exiting the radiation-based curing device. The module also can include a heat exchanger positioned along a flow path between the return reservoir and the supply reservoir. The heat exchanger can remove heat energy from the heated flow of fluid and direct the flow of fluid back into the supply reservoir.

In one embodiment, a method of cooling a UV curing system includes directing a flow of cooling fluid from a supply reservoir past a UV lamp source, the flow of fluid operable to remove heat energy from the UV lamp source. The heated flow of the cooling fluid is directed from the curing chamber to a return reservoir, and the heat energy is removed from the heated flow of cooling fluid. The heat-removed flow of cooling fluid then is directed back into the supply reservoir, whereby the cooling fluid is operable to be re-circulated past the UV lamp source.

In one embodiment, a system for reducing the presence of ozone in a UV curing system includes a supply reservoir for containing a volume of fluid and a flow generating device operable to direct a flow of fluid from the supply reservoir past a UV lamp source, such that the flow of fluid can remove heat energy from the UV lamp source. A first run of piping connected to the curing chamber can receive the heated flow of fluid and direct the flow of heated fluid to an ozone destruction unit. The ozone destruction unit can receive the flow of heated fluid and reduce the concentration of ozone contained therein. A second run of piping connected between the ozone destruction unit and the supply reservoir then can direct the ozone-reduced flow of fluid hack into the supply reservoir. The ozone destruction unit can include a catalyst selected to cause a reaction with the heated flow of fluid that breaks down at least a portion of any ozone contained in the fluid. The catalyst can be any appropriate catalyst for breaking down ozone, such as is selected from the group consisting of MnO₂/CuO, MnO₂/CuO/Al₂O₃, activated carbon, Pd/MnO₂, Pd/MnO₂/Silica-Alumina, MnO₂ based catalysts, and precious metal pt/pd catalysts. The catalyst can be in the form of pellets contained in the ozone destruction device, or can be in the form of a coating on one of a honeycomb and a radiator device in the ozone destruction device.

In one embodiment, an ozone destruction apparatus for reducing the presence of ozone in a UV curing tool includes a housing having an inlet for receiving a flow of fluid exiting the curing tool and an outlet for outputting an ozone-reduced flow of fluid to be recirculated through the curing tool. A flow path in the housing is configured to direct the received flow of fluid in the housing, the flow path having a length and shape such that the flow of fluid has a selected residence time in the flow path for a given flow rate. A catalyst is positioned on a surface of the flow path, or in the flow path, such that the flow of fluid in the flow path is in contact with the catalyst for the selected residence time. The catalyst is selected to cause a reaction with the flow of fluid that breaks down at least a portion of any ozone contained in the fluid, producing the ozone-reduced flow of fluid output to be output from the housing and re-circulated back into the curing system. The flow path can be in the form of a radiator or a honeycomb, for example.

In one embodiment, a method of reducing the presence of ozone in a UV curing tool includes receiving a flow of heated fluid exiting the UV curing tool. The flow of heated fluid is directed along a flow path having a length and shape such that the flow of fluid has a selected residence time in the flow path for a given flow rate. The flow path has a catalyst positioned on a surface thereof, or contained therein, whereby the flow of fluid in the flow path is in contact with the catalyst for the selected residence time. The catalyst is selected to cause a reaction with the flow of fluid that breaks down at least a portion of any ozone contained in the fluid. The ozone-reduced flow of fluid then is directed from the flow path back to the UV curing tool, whereby the flow of fluid can be re-circulated through the UV curing tool.

Other embodiments will be obvious to one of ordinary skill in the art in light of the description and figures contained herein.

### BRIEF DESCRIPTION OF THE DRAWINGS

Various embodiments in accordance with the present invention will be described with reference to the drawings, in which:

FIG. 1 illustrates a prior art cooling system for a curing device;

FIG. 2 illustrates a UV curing device and cooling system that can be used in accordance with one embodiment of the present invention;

FIGS. 3(a) and (b) illustrate, respectively, front and side views of a cooling module that can be used in accordance with one embodiment of the present invention;

FIGS. 4(a) and 4(b) illustrate, respectively, top and side views of a blower device that can be used in accordance with one embodiment of the present invention;

FIG. 5 illustrates a gas-separating membrane that can be used in accordance with one embodiment of the present invention;

FIG. 6 illustrates a curing system that can be used in accordance with one embodiment of the present invention;

FIG. 7 illustrates steps of a method that can be used in accordance with one embodiment of the present invention.

FIG. 8 illustrates a curing and cooling system that can be used in accordance with one embodiment of the present invention;

FIG. 9 illustrates an ozone destruction unit that can be used in accordance with one embodiment of the present invention;

FIG. 10 illustrates results for an ozone destruction unit that can be used in accordance with one embodiment of the present invention;

FIG. 11 illustrates results for an ozone destruction unit that can be used in accordance with one embodiment of the present invention;

FIG. 12 illustrates results for an ozone destruction unit that can be used in accordance with one embodiment of the present invention;

FIG. 13 illustrates results for an ozone destruction unit that can be used in accordance with one embodiment of the present invention; and

FIG. 14 illustrates steps of a method that can be used in accordance with one embodiment of the present invention.

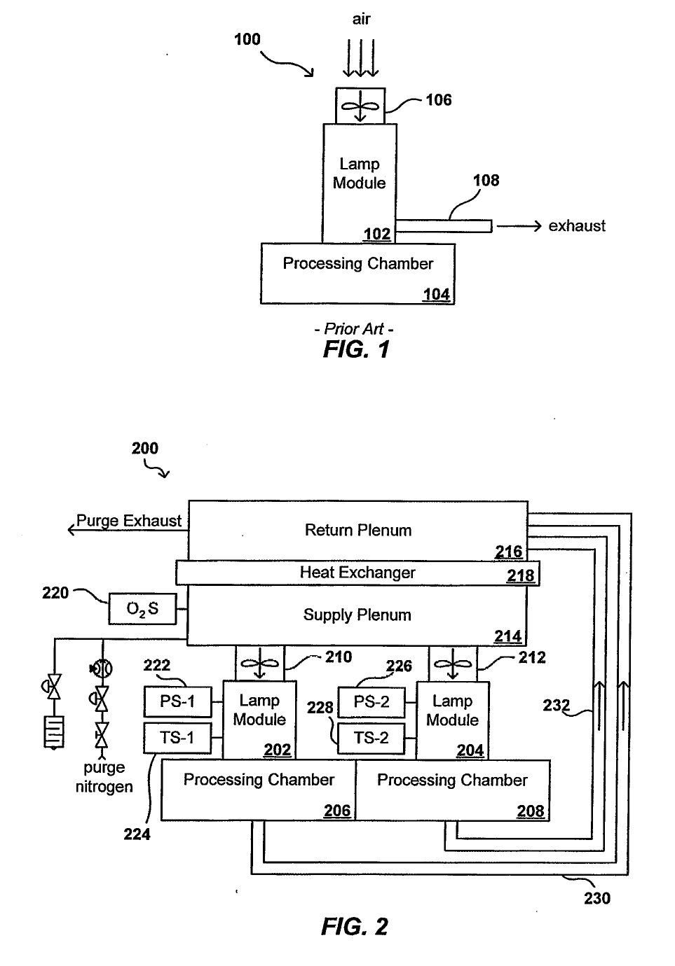

### DETAILED DESCRIPTION OF THE INVENTION

Systems and methods in accordance with various embodiments of the present invention can overcome the aforementioned and other deficiencies in existing curing and other radiation-utilizing applications. In one embodiment, a cooling module is used to cool a radiation source (e.g., a UV lamp), the cooling module being operable to recirculate cooling fluid (e.g., nitrogen gas) through the source so as to reduce the load on the exhaust system for the production line or fabrication facility. The recirculation of a selected fluid, as opposed to the introduction of a flow of air into the system, also can provide for the reduction and/or elimination of seal requirements from users of the system, as the amount of the selected cooling fluid leaking into the system is less critical that for water vapor and feed air, which can include higher levels of oxygen, for example. The module can use a simple heat exchanger that utilizes cooling water (such as process water or another appropriate liquid) to remove heat from the re-circulating fluid. The cooling module can utilize at least one inline blower (or other flow-inducing device) in order to generate and direct a high velocity flow of fluid (such as forced gas) to the radiation source, which can include a magnetron and UV bulb in a UV lamp module, for example. In one embodiment, pure nitrogen gas and/or nitrogen enriched air is used as the re-circulating fluid to reduce the formation of ozone formation inside the cooling system. The use of pure nitrogen gas also can reduce the amount of UV radiation (particularly at wavelengths less than 200 nm) absorbed by oxygen in the re-circulating fluid, thus increasing the UV intensity or irradiance output to the workpiece being exposed to the UV radiation. A catalyst can be used inside the recirculation system to remove any residue ozone. In one embodiment, an ozone destruction unit is embedded or otherwise integrated into the recirculation system to reduce the amount of ozone, and the corresponding consumption of purge nitrogen, for example. The return fluid is heated by the radiation source, such that no external heat input is needed for the catalyst to reach high ozone destruction efficiency.

FIG. 2 illustrates an exemplary curing system 200 including an integrated recirculated gas cooling system that can be used in accordance with one embodiment. This particular curing system includes a pair of lamp modules 202, 204, each of which can include a magnetron and UV lamp (Hg bulb) to provide UV radiation for UV curing applications. Each lamp module 202, 204 directs UV radiation to a respective processing chamber 206, 208, or portion of a processing chamber, each of which can be used for UV curing of a respective workpiece (such as a semiconductor wafer) as known in the art and discussed above. Each lamp module has a pressure sensor 222, 226 and temperature sensor 224, 228 for monitoring the pressure and temperature inside the respective lamp module. These sensors can be used to adjust the flow of a cooling fluid, such as nitrogen gas, directed through the lamp modules, and/or to adjust the temperature of the re-circulating fluid by adjusting an amount of cooling liquid flowing through the heat exchanger 218, as discussed below.

Each lamp module 202, 204 in this embodiment has a respective blower 210, 212 positioned and operable to direct a controllable flow of cooling fluid into the respective module. The blowers can be any appropriate device operable to generate and/or direct a flow of a cooling fluid into the respective module, such as a blower operable to generate on the order of about 1400 CFM of cooling fluid per chamber. It also should be understood that it is not necessary to have one blower for each module or chamber, as a single blower, for example, could be used to provide a flow that is subsequently bifurcated and directed to separate modules and/or chambers.

The blowers 210, 212 can direct a cooling fluid from a cooling fluid supply, such as a supply plenum 214 or other (typically positive pressure) source of fluid. The supply plenum 214 can receive a flow of purge gas, such as pure nitrogen or nitrogen enhanced gas, to replace any gas lost due to leakage or consumption during the cooling and recirculation process. The supply plenum 214 also can have at least one gas sensor, such as an oxygen sensor 220 for monitoring oxygen levels in the re-circulating fluid. The blowers can direct the cooling fluid through the lamp modules 202, 204 into the respective curing chambers 206, 208, then the heated fluid can be directed through re-circulating lines 230, 232 into a return plenum 216 or other chamber or reservoir for receiving the heated fluid. A heat exchanger 218 can be positioned between the return plenum 216 and the supply plenum 214, or at least along a flow path between the return and supply plenums, so that heat can be removed from the recirculated fluid before the fluid is directed back to the lamp modules.

In one embodiment, the curing system is a UV curing system composed of one or more UV modules including but not limited to UV lamps powered by Microwave, RF, and/or DC energy sources. The UV source can be designed or selected to meet specific UV spectral distribution requirements in order to perform curing and chamber cleaning, which is achieved by using one, two, or more different types of UV lamps (e.g., low pressure Hg, medium pressure Hg, high pressure Hg, etc.) within the same array inside the chamber cavity. The chamber cavity is operable to support a heated susceptor under vacuum, where a workpiece such as a silicon wafer can be placed to receive the UV energy during a curing process.

A sufficient amount of cooling fluid is directed into the lamp modules to cool down the magnetron and UV lamp. For an exemplary DSS (Dual Sweeping Source) UV chamber, about 1400 CFM of cooling air is needed per chamber, requiring 4200 CFM of cooling air for one Producer SE system having 3 DSS Nanocure UV chambers (the Nanocure UV chambers available from Applied Materials, Inc. of Santa Clara, Calif.), This can be a very high load for a facility exhaust system, and without the re-circulating apparatus can exceed customer fabrication facility capacity.

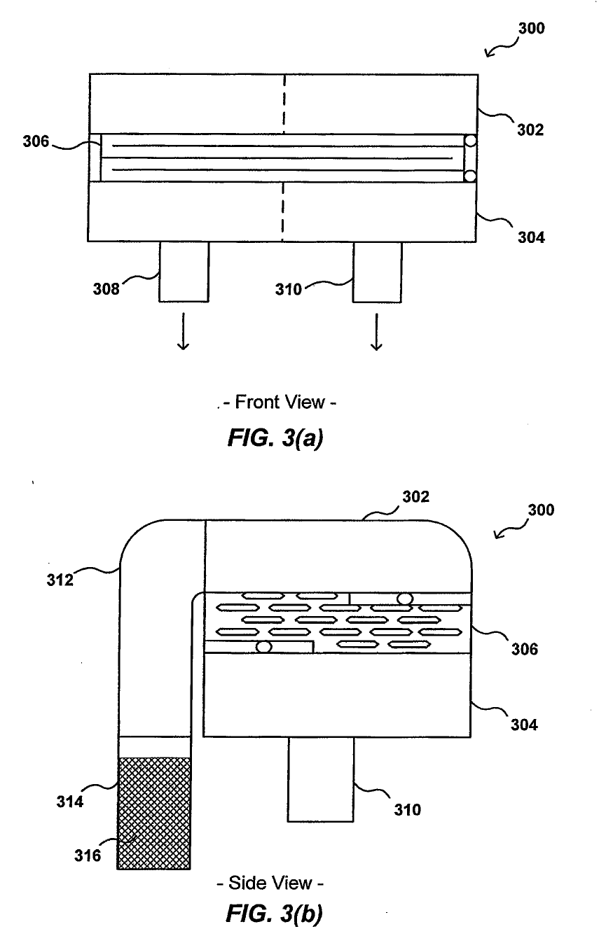

In one embodiment shown in FIGS. 3(a) and 3(b), a recirculation cooling air device 300 includes a pair of inline blowers 308, 310. The returning, heated air is received from a return duct 312 (and any necessary extension duct 314) to a return reservoir 302, then cooled by a water chilled heat exchanger 306 before passing back into the supply reservoir 304. A stream of make-up gas is used to compensate for any leak in the recirculation apparatus. A pellet or honeycomb catalyst 316 as discussed elsewhere herein can be placed in the return reservoir 302, but in at least some embodiments is instead placed in the extension duct 314 for ease of service.

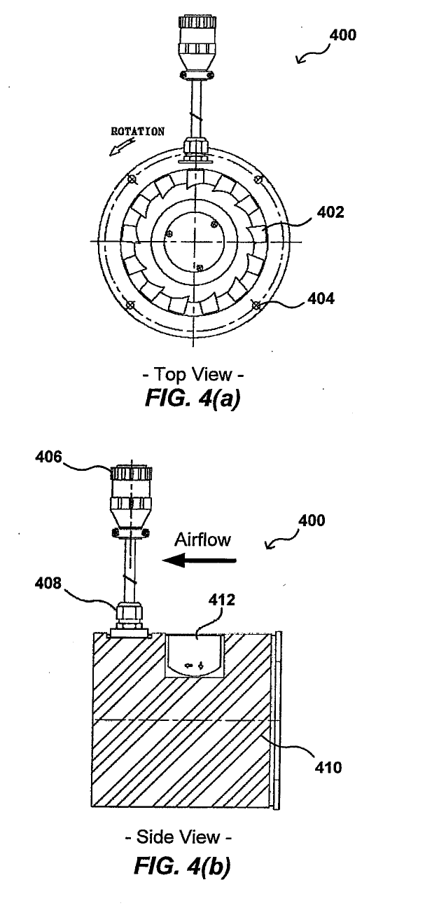

FIGS. 4(a) and 4(b) show an exemplary blower 400 that can be used in such a cooling air device. This blower 400 includes a rotating fan 402 operable to direct an appropriate flow of fluid for cooling the respective UV lamp module, such as a flow of at least 7″ water gauge force air. The blower is shown to include a connector 406 and liquid-tight fitting 408, as well as a nameplate 412 and vibration damping material 410. As can be seen, the attachment points 404 are located equidistant about a periphery of the rotating fan in order to balance the blower and reduce vibration in the device. Such a blower can be, for example, model AMETEK® Rotron 041-402000 available from AMETEK® Technical & Industrial Products of Kent, Ohio.

A significant concern is that the ozone accumulation in the recirculated will exceed OSHA or other applicable standards. A recirculation system in accordance with one embodiment uses pure nitrogen as a make-up gas to mitigate this issue. A nitrogen purge gas can remove and/or reduce the oxygen concentration in the recirculation apparatus to less than about 1%. An oxygen sensor can be integrated into the recirculation system to monitor the oxygen concentration inside the re-circulating gas flow in order to ensure a proper purge of oxygen.

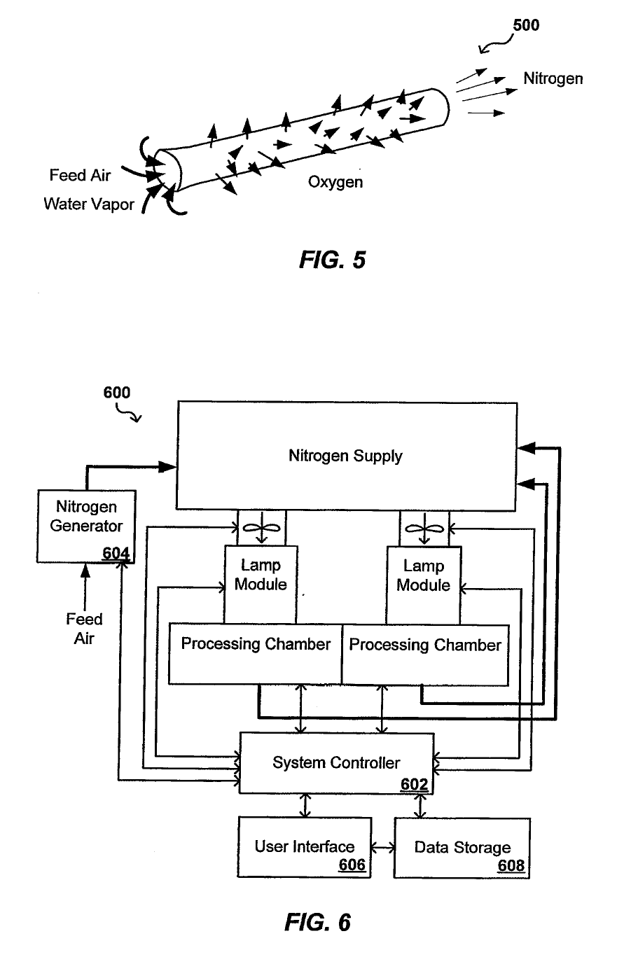

As discussed above, a flow of nitrogen or nitrogen enhanced gas can be used advantageously as the re-circulating cooling fluid. Due to factors such as leaks and absorption, a steady source of nitrogen is needed to supplement the supply in the cooling system. Since providing a flow of pure nitrogen can increase costs and system complexity as known in the art, the cooling fluid system can incorporate a nitrogen-producing or extracting device capable of producing a sufficient amount of nitrogen or nitrogen enhanced gas. One such device is a membrane-containing device operable to generate a flow of nitrogen from a flow of air input into an end of a tubular membrane, for example. Such a membrane 500 is shown in FIG. 5, wherein a flow of feed air (which will also contain some level of water vapor) is fed into an end of the tubular membrane 500. As the air passes through the membrane, a substantial amount of oxygen (and other components) will pass through the walls of the membrane, such that the air passing through the output end of the tubular membrane is substantially nitrogen, or at least has a significantly increased proportion of nitrogen compared to the feed air input into the tubular membrane. An exemplary membrane system works to separate air into its component gases by passing compressed air through a bundle of hollow fiber, semi-permeable membranes. The membrane divides the air into two streams, one of which is essentially nitrogen. The other stream contains oxygen, CO₂, and other trace gases. Millions of fibers, about the size of human hair, can be packed into a single module. This provides a very large membrane surface area that efficiently produce large quantities of high nitrogen purity product stream. An example of such a membrane system is an MG Generon® 6500 nitrogen membrane available from Innovative Gas Systems (IGS) of Pittsburg, Calif. Such a device can ensure that a proper amount of nitrogen, such as on the order of about 250 liters/minute, is available for injection into the system.

FIG. 6 illustrates an overall UV curing system with control and cooling 600 in accordance with one embodiment of the present invention. As can be seen, the overall system can be controlled and/or monitored through the use of a system controller 602. The system controller can be any appropriate combination of hardware and/or software known or used in the industry for receiving signals indicating the status of various components and/or parameters for the system and generating control signals in order to control and adjust various components and/or parameters. In one example, this controller takes the form of a personal computer having a number of signal inputs and outputs, the computer having access to instructions for monitoring and controlling various aspect of the system.

The system controller 602 in FIG. 6 is shown to be in communication with a number of components, such as the blowers (for monitoring and/or controlling fan speed) and the lamp modules (for monitoring and controlling the generation of radiation in the system). The system controller also can be in communication with various other sensors and monitoring devices as discussed elsewhere herein and as known in the art for monitoring the system status. For example, the system controller 602 is in communication with the nitrogen generator 604. As discussed above, the nitrogen generator accepts a flow of feed air and separates the component gases, resulting in a flow of nitrogen directed into the supply reservoir. The system controller 602 can receive a signal such as a monitoring signal from a nitrogen monitor indicating the concentration of nitrogen being directed into the nitrogen reservoir. If the amount of flow from the nitrogen generator, or other nitrogen source, is not sufficient, the system controller can generate a control signal instructing the nitrogen generator or source to increase the flow of nitrogen into the system. If the system controller notices that the nitrogen content is below a nitrogen threshold, such as may be stored in a data storage device 608 for the system, then the system controller can generate an alert signal indicating that the nitrogen generator is not functioning properly, and may require maintenance such as the replacement of the catalyst. The system controller can send this alert signal to an appropriate device, such as an alarm that alerts an operator of the system. In this example, the signal is sent to a user interface device 606, such as a personal computer or wireless-enabled PDA, which allows a user or operator of the system to be notified that the nitrogen generator requires attention. The user interface also can allow the user or operator to observe the various monitored parameters and components of the system, and can allow the user or operator to adjust or control various settings and parameters for operation of the system as known in the art.

As would be apparent to one of ordinary skill in the art, the system controller can monitor various aspects of the overall system, such as the flow rate, pressures, temperatures, gas component levels, etc., by receiving signals from the appropriate sensors, and can alert operators and/or control components to adjust parameters or perform maintenance as necessary. For example, the system controller can monitor the flow rate through the cooling system, and can adjust the speed of the blowers in response thereto. Various other uses and applications of the system controller, user interface, and data storage would be apparent to one of ordinary skill in the art in light of the descriptions and suggestions contained herein.

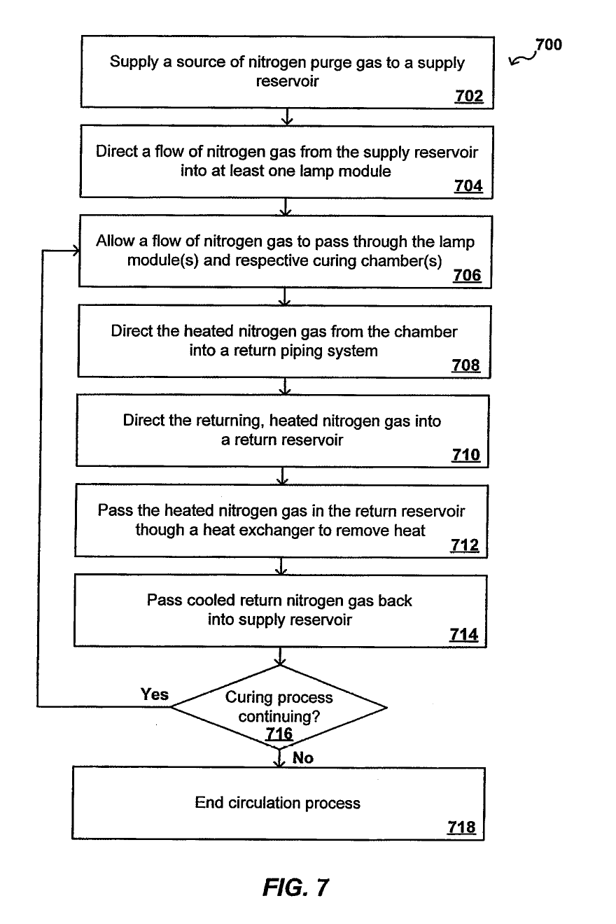

FIG. 7 shows steps of an exemplary method 700 for cooling a UV curing system in accordance with one embodiment of the present invention. In the method, a source of nitrogen purge gas is supplied to a supply reservoir 702. As discussed above, this can be pure nitrogen or nitrogen enriched gas, for example, and can be generated by an appropriate device such as a component-separating membrane device. The nitrogen gas is directed into at least one lamp module via at least one blower 704. The gas passes through the lamp module and the respective curing chamber 706, and exits the chamber into a return piping system 708, thereby removing heat from the lamp module and curing chamber. The heated nitrogen gas is directed to a return reservoir 710, then passed through a heat exchanger 712 whereby heat is removed from the return gas, and passed back into the supply reservoir 714. If the curing process is continuing 716, then the gas is again directed through the lamp module and processing chamber by the respective blower. Else, the circulation process ends 718.

As discussed above, the recirculation cooling system is not hermetically sealed. As such, small amounts of air (typically containing 20.9% Oxygen) may leak, or back stream, into the recirculation system. The presence of oxygen can result in the formation of trace amounts of ozone via UV irradiation, such as is given by the following formulae known in the art for atmospheric ozone formation and destruction from oxygen species:

O₂+hν→2O kᵢ(1/s)

O+O₂+M→O₃+M k₂(cm⁶/(molecule²s₁))

O₃+hν→O+O₂ k₃(1/s)

O+O₃→2O₂ k₄(cm³/(molecule¹s¹)),

where O is an oxygen atom, O₂ is a molecule of oxygen, O₃ is a molecule of ozone, hν is a photon of ultraviolet radiation, and M is any non-reactive species that can absorb the energy released in the second reaction (formation of ozone from oxygen and a third oxygen atom) to stabilize the ozone. M is not oxygen or nitrogen. Ozone is not a very stable molecule, and would tend to break back into O and O₂ if M did not absorb the excess energy. The rate constants are given by k₁ . . . k₄.

In order to comply with regulations such as current OSHA regulations, it is desired to maintain the ozone concentration below about 0.08 ppm in various UV cooling systems. This then can require the reduction or destruction of ozone produced in the systems. An ozone destruction unit can be added to the cooling system to control the amount of ozone circulating in the system. In one embodiment, an ozone destruction unit utilizes a catalytic reaction to abate ozone, as the active ingredient will not be consumed. Further, no external heat (energy) is required for these catalytic reactions, such as are given by the following formulae:

O₃+M→M-O+O₂

O₃+M-O→M+2O₂

### As can be seen, the end result of these reactions is simply the non-reactive species (already present) and oxygen.

An ozone destruction unit in one embodiment contains a low temperature oxidation catalyst, such as Carulite® (a volatile organic compound destruction catalyst available from, and a registered trademark of, Carus Chemical Company of Peru, Ill.), PremAir® (an ozone destruction catalyst available from, and a registered trademark of, Engelhard Corporation of Iselin, N.J.), activated carbon, MnO₂/CuO, MnO₂/CuO/Al₂O₃, Pd/MnO₂, or Pd/MnO₂/Silica-Alumina. The catalyst can be pellet size, for example, or can be a film coated on high surface area media such as a honeycomb, radiator, etc.

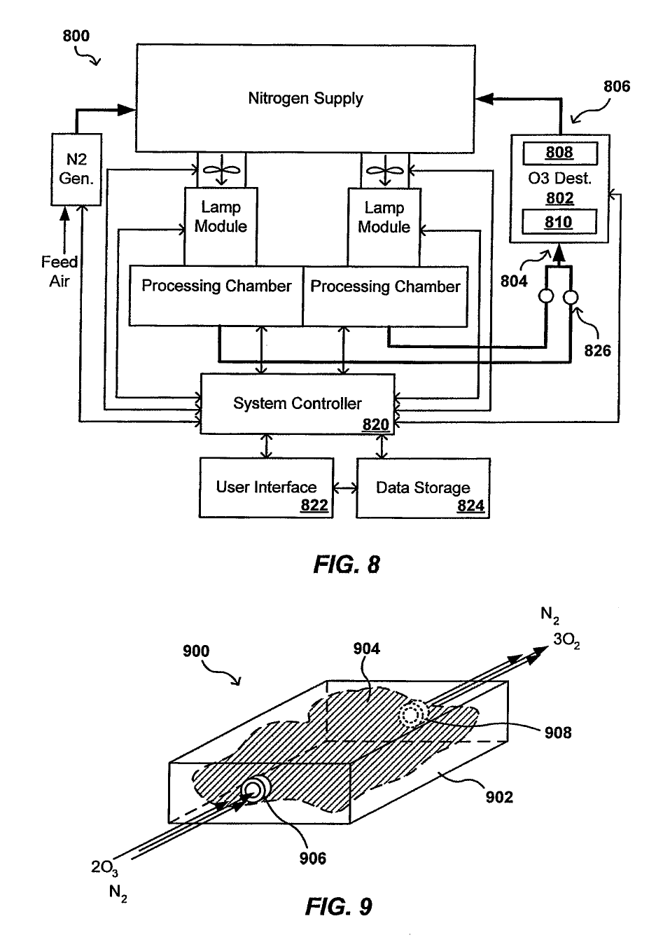

An ozone destruction unit 802 can be used with any appropriate cooling and/or recirculation system, such as the exemplary UV curing and recirculation cooling system 800 illustrated in FIG. 8. In this system, the ozone destruction unit 802 is shown to be positioned along the return lines, whereby the heated gas passes from the curing chambers into at least one inlet 804 of the ozone destruction unit 802, reacting with the catalyst 808 in the unit 802, then exiting at least one outlet 806 of the unit to be passed back to the gas supply, here a nitrogen supply reservoir. As shown in this example, the return lines are combined into a single return line before the nitrogen gas flow reaches the ozone destruction unit, such as by using suck-back valves 826 to ensure that gas returning from one curing chamber does not contaminate another chamber due to the combined flows. In other embodiments, the separate return lines might each feed directly into the ozone destruction unit. Further, although a single output line is shown between the ozone destruction unit, it should be understood that multiple output lines can bc used, as well as one ozone destruction unit for each return line and other such variations.

The ozone destruction unit 802 can include, or have connected thereto, an ozone sensor 810 operable to monitor a level of ozone in the cooling system. The sensor 810 and the ozone destruction unit can be in communication with a system controller 820, which can receive a signal from the ozone sensor and monitor the ozone level in response thereto. The controller can monitor the ozone levels, and can monitor other aspects such as a remaining lifetime of the catalyst, and can generate an alert when ozone levels reach or approach unacceptable levels, or when the catalyst needs to be changed or supplemented. The alert can be sent to a user interface 822, such as a personal computer or other interface mechanism or device as known or used in the art for informing a user or operator of information about the system. The system controller and/or user interface can be in communication with a data storage device 824, such as a database storing information about the system such as the standard catalyst lifetime and maximum ozone threshold.

The unit 802 also can include a media filter in addition to, or in place of, the catalyst. A media filter can be used to remove any undesirable particulates from the re-circulating gas flow. The filter can be any appropriate filter known or used in the art for such purposes. It should be understood that a media filter also can be contained in a unit separate from the catalyst destruction unit.

FIG. 9 shows a perspective view of an ozone destruction unit 900 that can be used in a system such as that shown in FIG. 8. In this unit 900, a catalyst 904 is contained in a housing 902 including an inlet 906 and an outlet 908. A flow of return gas including an amount of ozone is input into the unit 900, wherein the catalyst causes a reaction as discussed above such that the amount of ozone present in the gas flow is reduced. The gas passing out the outlet 908 then can include a substantially reduced amount of ozone, and may include oxygen and/or other byproducts of the reaction.

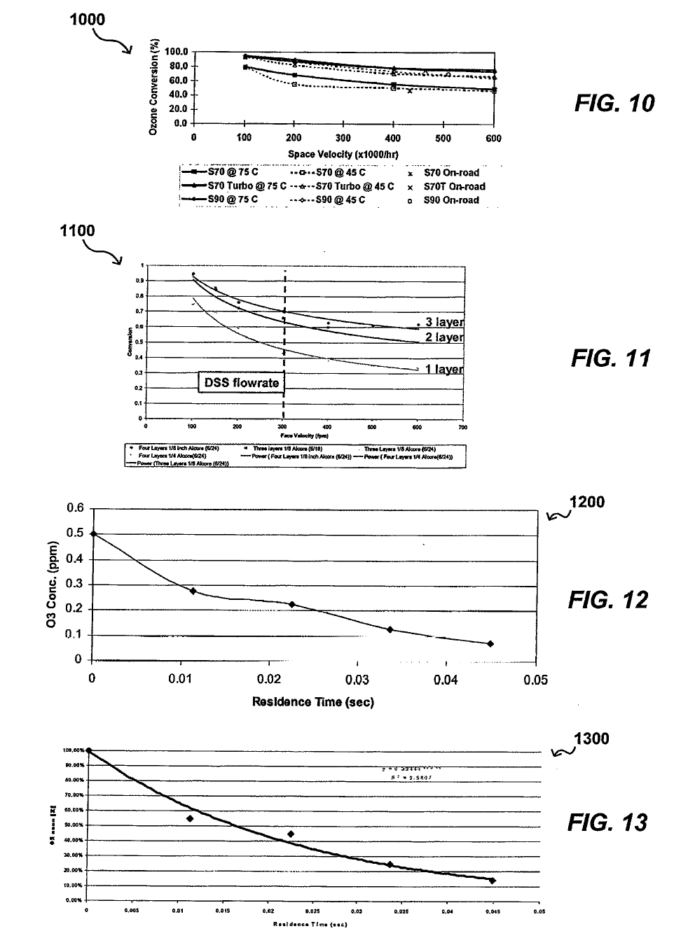

Although the catalyst is shown to be a free-flowing material inside the housing in the figure, it should be understood that the catalyst can be used in any appropriate manner known or used in the art, such as coating a passageway, paths, or network that the gas passes through, in order to control the flow of gas and the level of reaction in the unit. For example, a catalyst such as PremAir® can be coated on the interior surfaces of a radiator that the gas flow passes through in the unit. FIG. 10 shows a plot 1000 of the ozone conversion percentage as a function of space velocity (×1000/hr) for a PremAir® coated radiator implementation, wherein the destruction efficiency was determined to be about 85% at a flow of 5 ft/sec. and at 75° C. FIG. 11 shows a plot 1100 of the ozone conversion for a PremAir® coated honeycomb in the ozone destruction unit, where the honeycomb cell was a ⅛″ cell with ⅝″ thickness and 45° C., with a pressure drop of about 0.1″ wg/layer.

FIG. 12 shows another plot 1200 wherein the ozone concentration in parts per million is plotted against the residence time in seconds. For this plot, there was a flow of 350 CFM of cooling air in a 6″ duct, with an oxygen level of 20.9% and an air temperature of 65° C. As can be seen, a residence time of at least 0.04 seconds is needed to get the ozone level below 0.08 ppm. FIG. 13 shows a plot 1300 of the data having a best fit line, wherein the 0.08 ppm value is shown to be obtained at between 0.04 and 0.045 seconds, such that any residence time of 0.045 or greater is sufficient in such a system to reduce the amount of ozone in the gas to the desired level stated above. For other ozone levels, the flow rate and/or or path length can be adjusted to increase or decrease the residence time accordingly.

The temperature can also have an effect on the necessary residence or contact times needed for ozone destruction or abatement. Table 1 shows residence times and temperatures needed for various processes.

TABLE 1
Comparison of contact times and temperatures for ozone destruction

| | | Precious Metal | MnO₂ based |
|---|---|---|---|
| | Thermal destruction | pt/pd catalysts | catalyst |
| Temperature, ° C. | >300 | 50–75 | 22 |
| Residence time, sec. | 3 | 3 | 0.36–0.72 |

### For the data in Table 1, a DSS heat exchanger was used with a cross section of 19″×35″, with a total flow of 1400 CFM. The linear velocity was about 5 ft/sec and for a traditional catalyst, the thickness was >2 ft.

Many other catalysts can be used to reduce the amount of ozone in the cooling fluid. For example, activated carbon can be used to decompose ozone in nitrogen-enriched gas. Unfortunately, active carbon is consumed in the process such that a constant supply of active carbon is needed. Further, the use is limited to applications where the ozone concentration is relatively low. Using activated carbon also can present a fire danger, particularly for higher ozone concentrations or where ozone is generated from a concentrated oxygen source. Activated carbon typically is used in water treatment to remove excess ozone, and may generate carbon monoxide and carbon dioxide byproducts. Such a process also can generate particles through the ozone reaction that can flow into the system. Activated carbon reactions can follow the following formulae:

O₃+C→CO+O₂

O₃+CO→CO₂+O₂

Other catalysts that have been investigated include a Carulite® low temperature oxidation catalyst (MnO₂/CuO), as well as a Carulite® 200 catalyst in ozone engineering (MnO₂/CuO/Al₂O₃).

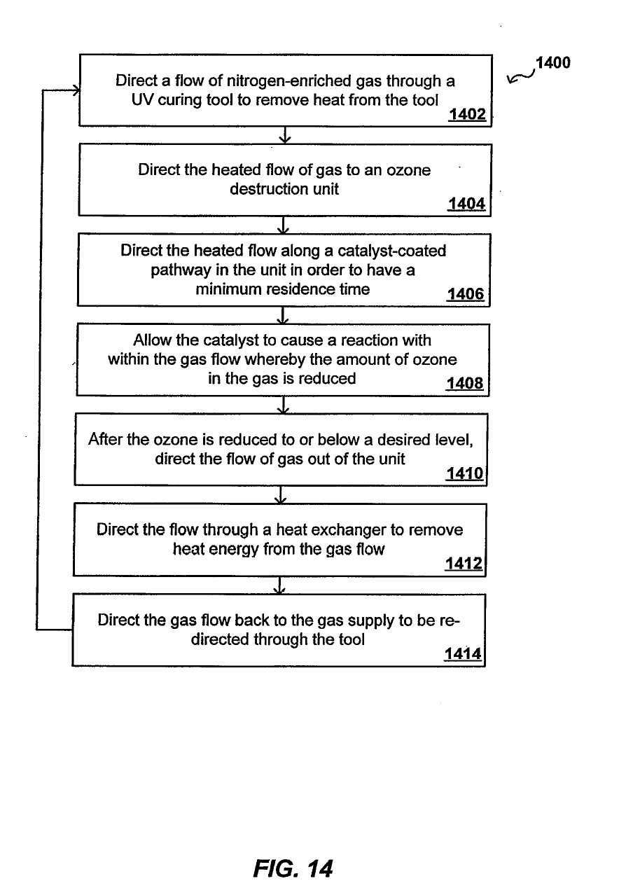

FIG. 14 shows steps of a method 1400 for ozone abatement that can be used in accordance with one embodiment of the present invention. In this method, a flow of nitrogen-enriched gas is directed through a UV curing tool, in order to remove heat from the tool 1402. The heated flow is directed to an ozone destruction unit 1404. The flow is directed along a catalyst-coated pathway in the unit in order to have a minimum residence time in the unit 1406. As the gas passes along the pathway, the catalyst causes a reaction within the gas flow whereby the amount of ozone in the gas is reduced 1408. After the amount of ozone is reduced to or below a desired level, the flow of gas is directed out of the unit 1410. The ozone-reduced gas flow then is directed through a heat exchanger in order to remove excess heat from the gas flow 1412. The cooled gas flow then is directed back through the UV curing tool 1414. It should be understood that the description and order of these steps is merely exemplary, and that other variations would be apparent to one of ordinary skill in the art in light of the descriptions and suggestions contained herein.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A system for reducing the presence of ozone in a UV curing system including a UV lamp source and a curing chamber, comprising:
a supply reservoir operable to contain a volume of fluid;
a flow generating device operable to direct a flow of fluid from the supply reservoir past the UV lamp source, the flow of fluid operable to remove heat energy from the UV lamp source;
a first run of piping connected to the curing chamber and operable to receive the heated flow of fluid and direct the flow of heated fluid;
an ozone destruction unit operable to receive the flow of heated fluid and reduce the concentration of ozone contained therein; and
a second run of piping connected between the ozone destruction unit and the supply reservoir and operable to direct the ozone-reduced flow of fluid back into the supply reservoir.

2. A system according to claim 1, wherein:
the ozone destruction unit includes a catalyst selected to cause a reaction with the heated flow of fluid that breaks down at least a portion of any ozone contained in the fluid.

3. A system according to claim 2, wherein:
the catalyst is selected from the group consisting of: MnO₂/CuO, MnO₂/CuO/Al₂O₃, activated carbon, Pd/MnO₂, Pd/MnO₂/Silica-Alumina, MnO₂ based catalysts, and precious metal pt/pd catalysts.

4. A system according to claim 2, wherein:
the catalyst is in the form of pellets contained in the ozone destruction device.

5. A system according to claim 2, wherein:
the catalyst is in the form of a coating on one of a honeycomb and a radiator device in the ozone destruction device.

6. A system according to claim 1, further comprising:
a heat exchanger operable to remove heat energy from the heated flow of fluid before the flow of fluid is directed back into the supply reservoir.

7. A system according to claim 6, wherein:
the heat exchanger is a water-cooled heat exchanger.

8. A system according to claim 1, wherein:
the fluid is one of a nitrogen gas and a nitrogen-enriched gas.

9. A system according to claim 1, wherein:
the ozone destruction device is operable to receive multiple flows of fluid from the curing device.

10. A system according to claim 1, wherein:
the flow generating device is a circulating blower.

11. An ozone destruction apparatus for reducing the presence of ozone in a UV curing tool, comprising:
a housing including an inlet for receiving a flow of fluid exiting the curing tool and an outlet for outputting an ozone-reduced flow of fluid to be recirculated through the curing tool;
a flow path in the housing configured to direct the received flow of fluid in the housing, the flow path having a length and shape such that the flow of fluid has a selected residence time in the flow path for a given flow rate; and
a catalyst positioned on a surface of the flow path, such that the flow of fluid in the flow path is in contact with the catalyst for the selected residence time, the catalyst causing a reaction with the flow of fluid that breaks down at least a portion of any ozone contained in the fluid, producing the ozone-reduced flow of fluid output to be output from the housing and recirculated back into the curing system.

12. An apparatus according to claim 11, wherein:
the flow path is in the form of one of a radiator and a honeycomb.

13. An apparatus according to claim 11, wherein:
the catalyst is selected from the group consisting of: MnO₂/CuO, MnO₂/CuO/Al₂O₃ activated carbon, Pd/MnO₂, Pd/MnO₂/Silica-Alumina, MnO₂ based catalysts, and precious metal pt/pd catalysts.

14. An apparatus according to claim 11, wherein:
the catalyst is in the form of a film coating on an interior surface flow path.

15. An apparatus according to claim 11, wherein:
the fluid is one of a nitrogen gas and a nitrogen-enriched gas.

16. A system according to claim 1, wherein:
the housing is operable to receive multiple flows of fluid from the curing device.

17. A method of reducing the presence of ozone in a UV curing tool, comprising:
receiving a flow of heated fluid exiting the UV curing tool;
directing the flow of heated fluid along a flow path having a length and shape such that the flow of fluid has a selected residence time in the flow path for a given flow rate, the flow path having a catalyst positioned on a surface thereof whereby the flow of fluid in the flow path is in contact with the catalyst for the selected residence time, the catalyst selected to cause a reaction with the flow of fluid that breaks down at least a portion of any ozone contained in the fluid; and
directing the ozone-reduced flow of fluid from the flow path back to the UV curing tool, whereby the flow of fluid is operable to be re-circulated through the UV curing tool.

18. A method according to claim 17, wherein:
directing the flow of heated fluid through the flow path includes directing the flow through a flow path in the form of one of a radiator and a honeycomb.

19. A method according to claim 17, further comprising:
providing the catalyst, where the catalyst is selected from the group consisting of: MnO₂/CuO, MnO₂/CuO/Al₂O₃, activated carbon, Pd/MnO₂, Pd/MnO₂/Silica-Alumina, MnO₂ based catalysts, and precious metal pt/pd catalysts.

20. A method according to claim 17, further comprising:
coating an interior surface of the flow path with the catalyst.
